(19) United States
(12) Patent Application Publication
(10) Pub. No.: US 2026/0233487 A1
(43) Pub. Date: Aug. 13, 2026

(54) DIMENSIONAL APPLIQUE AND METHODS OF MAKING AND USING THE SAME

(71) Applicant: Stahls' Inc., St. Clair Shores, MI (US)

(72) Inventors: Micah Tom Leong, Grosse Pointe Woods, MI (US); Jonathan Samuel Fetty, Sterling Heights, MI (US); Fred Ciaramitaro, Washington, MI (US); Bretton Arthur Stahl, Grosse Pointe Farms, MI (US)

(21) Appl. No.: 19/535,104

(22) Filed: Feb. 10, 2026

Related U.S. Application Data
(60) Provisional application No. 63/756,789, filed on Feb. 10, 2025.

(51) Int. Cl. B32B 3/08; B29C 64/124; B29C 64/245; B29C 64/30; B29C 64/393; B32B 5/02; B32B 7/12; B32B 27/08; B32B 27/12; B33Y 10/00; B33Y 30/00; B33Y 40/20; B33Y 50/02; B33Y 80/00; B29L 9/00

(52) U.S. Cl. CPC B32B 3/085; B29C 64/124; B29C 64/245; B29C 64/30; B29C 64/393; B32B 5/02; B32B 7/12; B32B 27/08; B32B 27/12; B33Y 10/00; B33Y 30/00; B33Y 40/20; B33Y 50/02; B33Y 80/00; B29K 2995/0021; B29L 2009/00; B32B 2250/03; B32B 2262/0261; B32B 2262/0276; B32B 2307/404; B32B 2405/00

(57) ABSTRACT

A dimensional applique comprises a three-dimensional printed photopolymer structure with a base layer and raised layers defining full-color gradients and texture variation, and an adhesive layer configured to bond the applique to target surfaces. An apparatus includes a printing system depositing liquid photopolymer in successive layers, an ultraviolet curing system, a vacuum hold-down substrate handling system, and an integrated cutting system separating individual appliques using printed registration fiducials. A manufacturing method includes preparing a substrate with adhesive that activates below the photopolymer degradation temperature, depositing and curing photopolymer layers, and cutting appliques aligned with registration fiducials. Batch production enables multiple appliques per print cycle, increasing throughput compared to direct-to-garment printing. Application uses a heat press with bottom heating and a pressure distribution pad to protect dimensional features while activating the adhesive.

### CROSS-REFERENCE TO RELATED APPLICATION

This application claims the benefit and priority under 35 U.S.C. §119(e) of U.S. provisional application Ser. No. 63/756,789, filed on February 10, 2025, the content of which is incorporated herein by reference in its entirety.

### TECHNICAL FIELD

The present disclosure relates to dimensional applique produced using additive manufacturing techniques, and more specifically to three-dimensional photopolymer structures that are printed over adhesive layers to form applique that can be applied to apparel and related goods for enabling the efficient production of tactile, high-resolution designs on various substrates.

### BACKGROUND

Dimensional logos and graphics that provide both visual appeal and tactile engagement have become increasingly desirable across multiple industries. Customers seek raised, three-dimensional designs that stand out from traditional flat graphics, offering enhanced branding impact and aesthetic differentiation. Several existing technologies attempt to address this demand, including embroidery, PVC and rubber patches, thick vinyl products, and direct-to-garment three-dimensional printing using additive manufacturing. Each of these methods presents significant limitations related to production time, cost, design complexity, substrate compatibility, or customization flexibility, among other issues.

Traditional embroidery is limited in achievable heights and thicknesses, cannot produce smooth gradients or photographic detail, and often involves time-consuming production processes. Also, PVC and rubber patches typically require CNC-machined dies for each design, adding substantial costs and making them economically unfeasible for small runs or variable data applications. These patches cannot reproduce smooth gradients or photographic imagery, and color choices are limited to pre-mixed pigments. Thick vinyl products face similar limitations in color options and gradient capabilities, with labor-intensive cutting and weeding processes.

Direct-to-garment three-dimensional printing can produce tactile, full-color dimensional logos with gradients and photographic imagery. However, this approach suffers from severe throughput limitations because only one finished product is created per print. Additionally, printing errors can ruin entire garments, different garment types require custom fixtures or jigs, and the photopolymer materials have specific substrate requirements that restrict the range of compatible materials and garment constructions.

### SUMMARY

The present disclosure provides a dimensional applique and method and apparatus for producing a dimensional applique that includes a three-dimensional printed photopolymer structure and an adhesive layer. The photopolymer structure includes a base layer and a plurality of raised layers that create dimensional relief. The photopolymer structure defines a printed image featuring full-color gradients and texture variation, enabling photographic detail, smooth color transitions, and tactile surface effects. The adhesive layer is disposed beneath the base layer and configured to bond the dimensional applique to a target surface, which may be a textile, hard surface, or other substrate. The corresponding method and apparatus are provided for producing a dimensional applique using a photopolymer-based additive manufacturing in combination with prepared substrates forming an adhesive layer. The method and apparatus allow for the efficient production of raised images with photographic detail, smooth gradients, and complex textures, expanding the available visual and tactile effects for branding, decoration, and personalization of apparel and related textiles and goods.

In some implementations, the adhesive layer includes a thermally activated hot-melt adhesive suitable for bonding to textiles, or a pressure-sensitive adhesive that bonds to surfaces without requiring heat activation. The thermally activated adhesive may be thermoplastic polyurethane, polyester-based hot-melt adhesives, polyolefin-based adhesives, or other suitable materials. The adhesive is configured to activate at a temperature below the degradation or distortion temperature of the cured photopolymer, preserving the dimensional structure during application. In additional examples, the adhesive layer includes a pressure-sensitive adhesive that forms a bond to a target surface when pressure is applied. The adhesive layer can be heat-activated, pressure-sensitive, or combinations thereof, and specifically formulated for specialized applications, ensuring strong adhesion while maintaining flexibility and wash resistance.

The three-dimensional photopolymer structure, in some implementations, includes varying material hardness and flexibility within a single printed object, providing customized tactile effects. The photopolymer structure may comprise at least two different colored photopolymers deposited simultaneously during printing to create full-color gradients. The raised layers, in some examples, define three-dimensional textures including wood grain, diamond plate, carbon fiber patterns, or other surface treatments. Examples of the photopolymer structure typically have a maximum height ranging from 0.5mm to 5mm above the base layer, though other dimensions are contemplated.

In some implementations, the dimensional applique also includes a substrate layer disposed between the photopolymer structure and the adhesive layer. The substrate layer may be selected from polyester fabric, nylon fabric, polyethylene terephthalate film, polyurethane film, or other suitable carrier materials. In alternative examples, the adhesive layer is applied directly to a release-coated carrier, eliminating the need for a separate fabric substrate.

According to another aspect of the disclosure, an apparatus for producing dimensional applique includes a printing system configured to deposit liquid photopolymer onto a prepared substrate in successive layers to form a three-dimensional structure. An ultraviolet curing system is positioned to cure each deposited layer immediately after deposition, enabling rapid layer buildup and preventing material flow or sagging. The printing system, in some examples, includes multiple print heads configured to simultaneously deposit different photopolymer materials having different mechanical properties, textures, and colors within a single print cycle. This capability enables the production of appliques with complex color gradients, varying durometer properties, and integrated support structures in a single operation.

In some implementations, the apparatus includes a cutting system integrated with the printing system. The cutting system is configured to separate individual dimensional appliques from the substrate based on pre-defined cut contours. In some examples, the cutting system includes a laser cutter, such as a CO₂ laser, or a blade-based cutting mechanism. Also, in some examples, registration fiducials are printed as part of the three-dimensional structure, such as small, raised squares or markers positioned around the perimeter of each applique. An optical registration system, as within some cutting systems, detects these fiducials and aligns the cut paths with the printed structures, ensuring accurate separation even if the substrate has shifted slightly during handling. The optical registration system, in some examples, captures images of the printed substrate, identifies the registration fiducials, and provides precise cutting coordinates to align with the printed structures.

In additional implementations, the apparatus includes an adhesive application system that is configured to apply an adhesive layer to the substrate before printing. The adhesive application system may apply adhesive through lamination, screen printing, spray deposition, or selective printing in patterns corresponding to the areas where photopolymer. will be deposited. The adhesive layer, in some examples, is configured to activate at a temperature below a degradation temperature of the cured photopolymer.

In further implementations, the apparatus includes a substrate handling system that provides a vacuum hold-down platform for securing the substrate during printing and cutting operations. In some examples, optical sensors detect the positioning of the substrate and adjust vacuum hold-down force to maintain precise alignment throughout the manufacturing process.

According to yet another aspect of the disclosure, a method of manufacturing a dimensional applique involves preparing a substrate with an adhesive layer configured to activate at a temperature below a degradation temperature of a cured photopolymer. A liquid photopolymer is deposited onto the substrate using a printing system to form a three-dimensional structure in successive layers. Each deposited layer is cured with ultraviolet light immediately after deposition. After printing is complete, in some examples, the three-dimensional structure is cut from the substrate using a precision cutting system, which may be aligned with identified features, such as registration fiducials. The registration fiducials, in some instances, are formed as part of the three-dimensional structure during printing. The dimensional applique is then removed from the substrate for subsequent application to a target surface.

In some implementations, the substrate is prepared by laminating a roll of adhesive material to a roll of substrate material, and converting the laminated material into sheets dimensioned to fit a print bed of the printing system. In other examples, the substrate is prepared by printing adhesive in a pattern onto a release-coated carrier. And, in additional examples, the substrate is prepared by precisely cutting adhesive from a laminated sheet and weeding away excess material.

In examples where multiple individual dimensional appliques are provided, the dimensional appliques are arranged in a nested configuration on the substrate. The nesting configuration, in some implementations, is determined based on multiple variables, including the number of appliques desired, the applique shape, the size of the print bed, and the number of print heads, among other setup and operational variables that may influence the shape and configuration of the nesting arrangement. The cutting step may then separate each individual applique based on respective pre-defined cut contours. This batch production approach maximizes the number of appliques produced per print cycle, significantly reducing the per-unit cost, for example, compared to direct-to-garment printing.

In examples where the adhesive layer is a thermally activated adhesive, the method further involves positioning the dimensional applique on a textile surface and applying heat and pressure using a heat press. The heat press, in these examples, may use bottom heat to activate the adhesive layer without directly exposing the raised photopolymer structure to the heat source, thereby avoiding damage or distortion to the outer surface of the photopolymer structure.

In some examples, a pressure distribution pad may be placed between a press platen and the three-dimensional structure during application. The pressure distribution pad may have mechanical properties, including specific thickness, durometer, and compressibility, which are configured to distribute force evenly across varying surface heights of the dimensional applique. This ensures uniform bonding across the entire applique while protecting delicate raised features.

The disclosed dimensional applique, apparatus, and method provide several key advantages. Photopolymer printing technology enables full-color, photographic-quality images with smooth gradients and fine detail, which are not available with embroidery, PVC patches, or thick vinyl. The dimensional appliques can be applied to any substrate compatible with the adhesive layer, including materials that cannot be directly printed with photopolymer. Also, by producing dimensional appliques that are subsequently applied onto garments, rather than printing directly onto garments, the manufacturing process can optimize print bed utilization and dramatically increase throughput. Depending on applique size, significantly more logos can be produced in a single print cycle compared to direct-to-garment approaches. This efficiency reduces per-unit cost and makes small-run and custom orders economically viable. The applique format also protects garments from waste, such as if a printing error occurs, the garment is not affected. The applique format eliminates the need for custom jigs and fixtures for different garment types, as application occurs in a separate step using standard heat press or hand application techniques.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a perspective view of an article of clothing, shown as a hat, having an affixed dimensional applique.

FIG. 2 is a front view of an article of clothing, shown as a shirt, having an affixed dimensional applique.

FIG. 3 is a perspective view of the dimensional applique of FIG. 1.

FIG. 4 is an exploded perspective view of the dimensional applique of FIG. 3.

FIG. 5 is a perspective view of the affixed dimensional applique taken at section V shown in FIG. 1.

FIG. 6 is a cross-sectional view of the affixed dimensional applique taken at line VI-VI shown in FIG. 1.

FIG. 7A is a schematic perspective view of a roll of a substrate material being fed over an adhesive material being fed from a roll to be laminated together.

FIG. 7B is a schematic perspective view of a roll of laminated substrate and adhesive material being separated into sheets.

FIG. 8 is a schematic top plan view of a printing system showing a print head on a gantry framework and its raster pattern path of movement over a print bed.

FIG. 9 is a schematic side view of the printing system showing a print head and a light source for a UV curing system.

FIG. 10A is a perspective view of a printing system depositing a layer of liquid photopolymer on a substrate material in a print bed.

FIG. 10B is a perspective view of the printing system of FIG. 10A with the liquid photopolymer deposited in layers to form three-dimensional printed photopolymer structures.

FIG. 10C is a perspective view of a cutting system outlining individual printed photopolymer structures shown in FIG. 10B.

FIG. 10D is a perspective view of the cutting system separating individual dimensional appliques from the substrate shown in FIG. 10C.

FIG. 11 is a perspective view of an additional dimensional applique.

FIG. 12 is an exploded perspective view of the dimensional applique of FIG. 11.

FIG. 13 is a perspective view of the affixed dimensional applique taken at section XIII shown in FIG. 2.

FIG. 14 is a cross-sectional view of the affixed dimensional applique taken at line XIV-XIV shown in FIG. 2.

FIG. 15A is a perspective view of a printing system depositing a layer of adhesive in a print bed in shapes of the intended photopolymer structures.

FIG. 15B is a perspective view of the printing system of FIG. 15A with the adhesive deposited in the shapes of the intended photopolymer structures.

FIG. 15C is a perspective view of the printing system of FIG. 15B depositing liquid photopolymer on the printed adhesive layer to form three-dimensional photopolymer structures.

FIG. 15D is a perspective view of a release carrier sheet being disposed over the printed photopolymer structures.

FIG. 15E is a perspective view of a heat source applying heat to the release carrier sheet to secure the sheet to the printed photopolymer structures.

FIG. 15F is a perspective view of a cutting system cutting the carrier sheet around the individual printed photopolymer structures shown in FIG. 15E.

FIG. 15G is a perspective view of the cutting system separating individual dimensional appliques from the carrier sheet shown in FIG. 15E.

FIG. 16A is a perspective view of a print bed holding an adhesive sheet.

FIG. 16B is a perspective view of a cutting system cutting the adhesive sheet shown in FIG. 16A into the shapes of the intended photopolymer structures.

FIG. 16C is a perspective view of the adhesive sheet of FIG. 16B being removed to leave adhesive pieces in the shapes of the intended photopolymer structures.

FIG. 16D is a perspective view of the adhesive shown in FIG. 16C disposed on the print bed in the shapes of the intended photopolymer structures.

FIG. 16E is a perspective view of a release carrier sheet being disposed over the photopolymer structures that are printed over the adhesive pieces shown in FIG. 16D.

FIG. 16F is a perspective view of a heat source applying heat to the release carrier sheet to secure the sheet to the printed photopolymer structures.

FIG. 16G is a perspective view of a cutting system cutting the carrier sheet around the individual printed photopolymer structures shown in FIG. 16F.

FIG. 16H is a perspective view of the cutting system separating individual dimensional appliques from the carrier sheet shown in FIG. 16G.

FIG. 17A is a cross-sectional view of a dimensional applique disposed on a fabric garment in a heat press.

FIG. 17B is a cross-sectional view of the dimensional applique shown in FIG. 17A heated in the heat press to melt and flow the adhesive to bond to the fabric garment.

FIG. 18A is a cross-sectional view of a dimensional applique disposed on a fabric garment over a support surface.

FIG. 18B is a cross-sectional view of the dimensional applique shown in FIG. 18A receiving downward pressure against the support surface to bond to the fabric garment.

FIG. 19A is a cross-sectional view of a dimensional applique disposed on a fabric garment in a press.

FIG. 19B is a cross-sectional view of the dimensional applique shown in FIG. 19A receiving downward pressure in the press to bond to the fabric garment.

FIG. 20 is a cross-sectional view of an affixed dimensional applique.

FIG. 21 is a flow diagram illustrating a method of making a dimensional applique.

FIG. 22 is a block diagram of a computer control system for operating the apparatus.

Like reference numerals indicate like parts throughout the drawings.

### DETAILED DESCRIPTION

Referring now to the drawings and the illustrative embodiments depicted therein, a dimensional applique is provided that combines the visual and tactile advantages of three-dimensional photopolymer printing with a manufacturing methodology that maximizes production efficiency, reduces per-unit costs, and enables application to a wide variety of substrates. The dimensional applique includes a three-dimensional printed photopolymer structure defining a printed image featuring full-color gradients and texture variation, enabling photographic detail, smooth color transitions, and tactile surface effects. The dimensional applique is printed over an adhesive layer that allows the dimensional applique to be stored and transported individually and subsequently, selectively placed on and applied to a desired location on an article, such as on a garment, textile, hard surface, or other substrate.

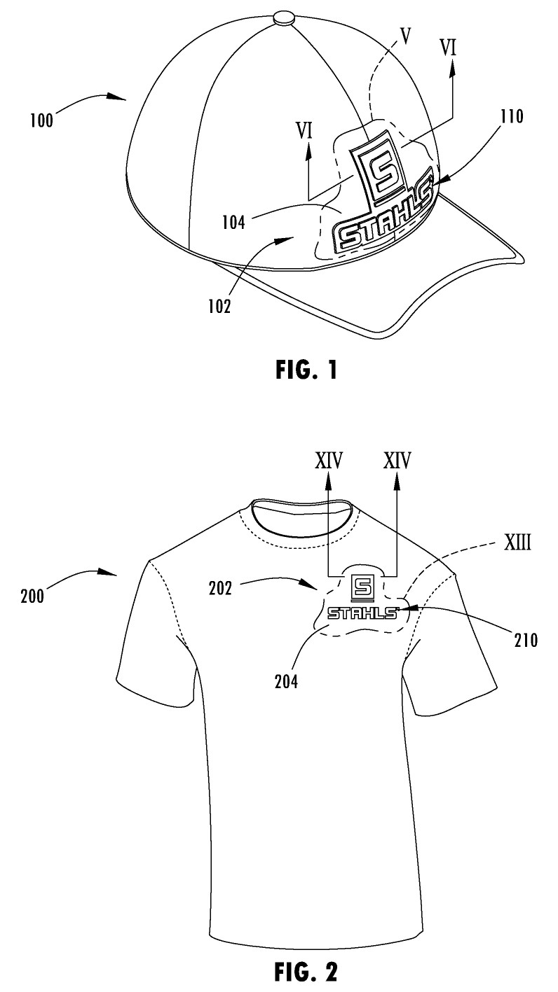

The dimensional applique can be used across a wide range of products and industries. As shown in FIG. 1, a dimensional applique 110 is applied to a garment 100, which is illustrated applied to a central area on a crown or front panel 102 of a hat 100. The dimensional applique 110 may also be applied on other locations of the hat 100, such as the back panel, side panels, or brim of the hat. The dimensional applique is flexible and capable of conforming to non-planar surfaces, such as the curved surface of the adhered central location on the front panel 102 of the hat 100. It is contemplated that the hat in other examples may be different types, sizes, and styles.

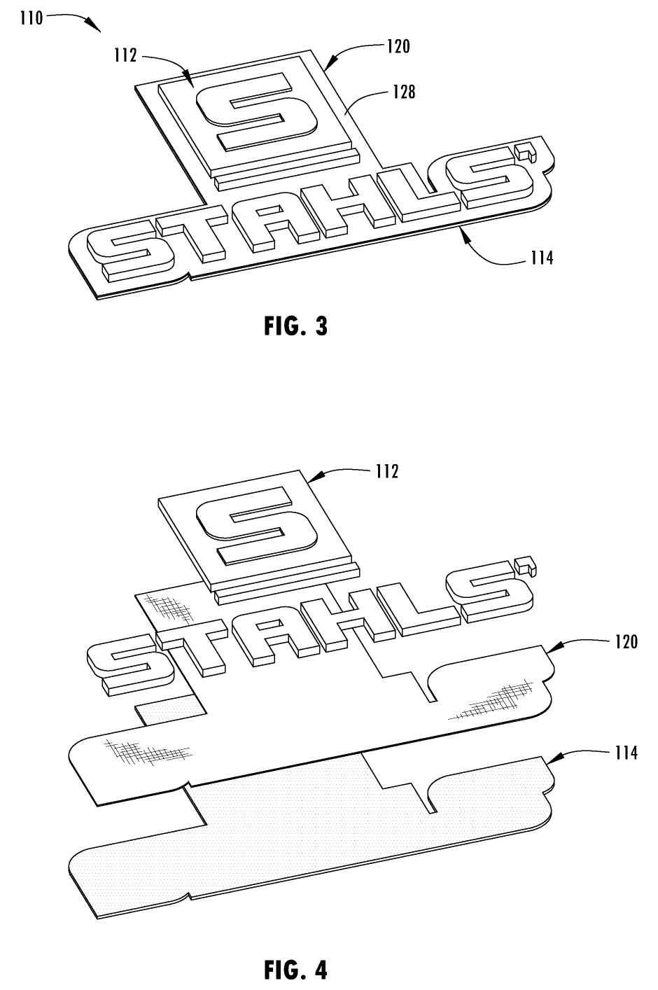

Also, as shown in FIG. 2, an additional example of a dimensional applique 210 is applied to an upper chest area 202 of a shirt 200. The shirt may be a t-shirt, as shown in FIG. 2, or in other examples may be a jersey, a polo shirt, or other garment, and the dimensional applique may be applied at various locations, including on the chest, back, sleeves, or other garment locations. The dimensional applique may also be applied to other articles of clothing or textile products, including jackets, pants, bags, backpacks, footwear, gloves, uniforms, and promotional items. Beyond textiles, the dimensional applique may further be applied to other fabrics and hard goods, including consumer electronics, automotive interior trim and exterior components, sporting equipment, signage, point-of-purchase displays, product packaging, and industrial equipment. The versatility of the dimensional applique enables application to planar and non-planar flexible textile substrates or rigid hard surfaces.

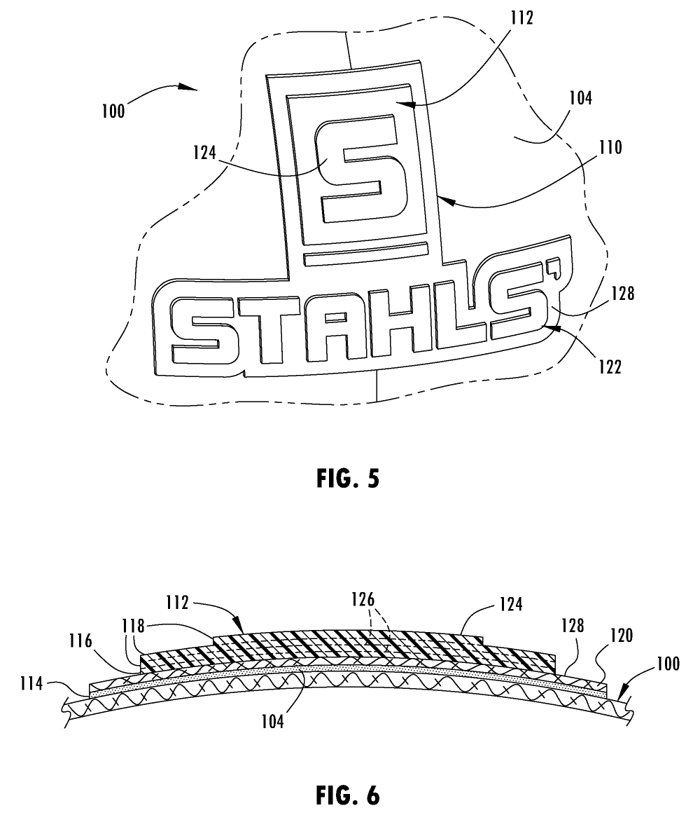

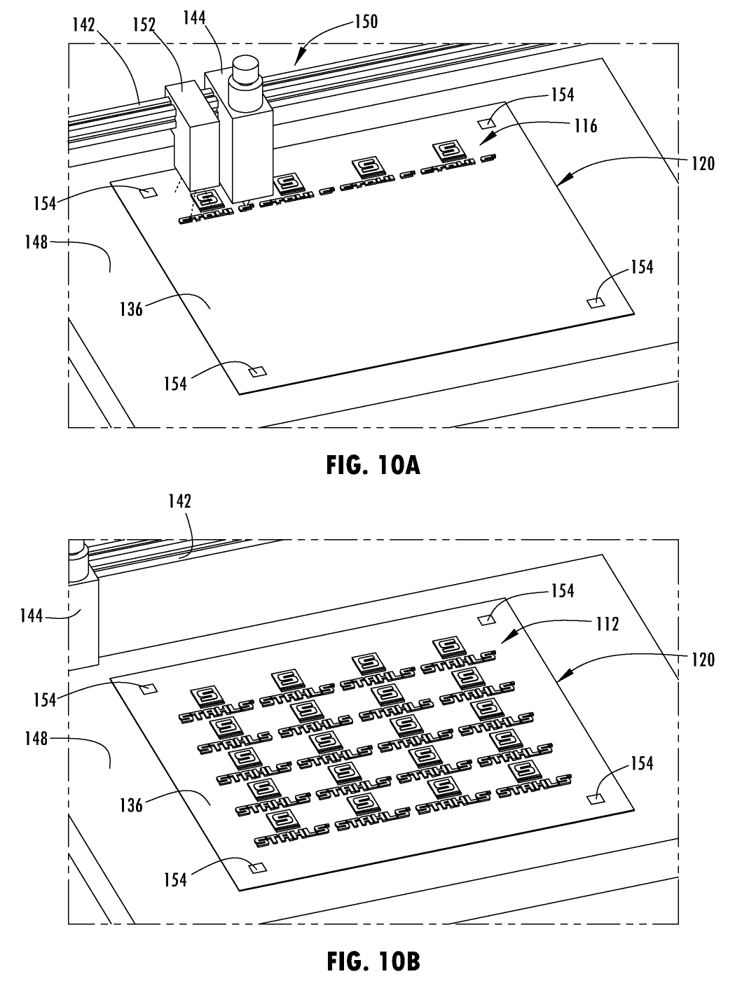

As shown in FIGS. 3-6, the dimensional applique 110 has a three-dimensional printed photopolymer structure 112 and an adhesive layer 114. The photopolymer structure 112 includes a base layer 116 and a plurality of raised layers 118 disposed on the base layer 116, such as shown in FIG. 6. The combination of the base layer 116 and the raised layers 118 creates dimensional relief, providing a raised, tactile surface that projects above the adhesive layer 114. The adhesive layer 114 is disposed beneath the base layer 116 and is configured to bond the dimensional applique 110 to a target surface 104, which again may be a textile material such as a garment or alternatively may be a hard surface such as plastic, metal, glass, or other substrates.

The photopolymer structure 112 defines a printed image 122 over the inner plane that underlies the adhesive layer 114, such that the image is visible from multiple angles from the outer side of the photopolymer structure 112. The printed image 122 formed by the photopolymer structure 112 features full-color gradients and texture variation. With respect to color, the printed image 122 may include photographic detail, smooth color transitions between multiple colors. Also, with respect to texture variation, the tactile surface effects formed by the outer surface of the photopolymer structure 112 enhance both visual appeal and physical engagement. In the examples shown in FIGS. 3-6, the printed image 122 displays a logo with the text "STAHLS" incorporating multiple colors, dimensional lettering, and raised surface features. Specifically, in the illustrated example shown in FIG. 6, the letter "S" is raised from the surrounding layers, forming the outermost layer of the raised layers 118. The outer surface 124 of the letter "S" is distinct from the surrounding outer surfaces 124, providing a different surface texture and rounded edges that provide added visibility.

The photopolymer structure 112 is formed from one or more liquid photopolymer materials that are deposited in controlled patterns and cured using ultraviolet light. The photopolymer materials may include rigid photopolymers, flexible elastomeric photopolymers, transparent photopolymers, and pigmented photopolymers in various colors. The photopolymer structure 112, in some examples, has at least two different colored photopolymers deposited simultaneously or in successive layers to create the full-color gradients of the printed image 122. For example, the photopolymer materials may include cyan, magenta, yellow, and black (CMYK) photopolymers that can be blended during deposition to produce a full spectrum of colors with photographic quality. White photopolymer may also be included to provide opacity and enhance color brightness and clear photopolymer may be used to create transparent or translucent effects.

The photopolymer structure 112 may also include regions of different material hardness and flexibility within a single printed object. As shown in FIGS. 3-6, the region forming the raised letter "S" has a flexible elastomeric photopolymer providing a soft-touch surface or compressible cushioning, which is different from the surrounding raised rectangle that has a rigid photopolymer providing structural integrity and sharp edge definition. The varying durometer properties enable creation of dimensional appliques with enhanced functionality. For example, a logo may have rigid lettering for crisp visual definition combined with a flexible background that conforms better to curved surfaces. Alternatively, certain design elements may incorporate soft elastomeric material to provide a pleasant tactile sensation when touched.

Further, three-dimensional textures can be produced in the outer surface 124 of the photopolymer structure 112. These textures can include simple ribbed or knurled surfaces for enhanced dexterity or more complex surface patterns, such as a wood grain pattern, a diamond plate pattern, a carbon fiber pattern, a leather grain pattern, a stone texture pattern, and a fabric weave pattern. These textures are not merely printed visual representations, but actual three-dimensional surface relief structures with varying heights that create authentic tactile effects. The ability to produce these realistic textures further distinguishes the dimensional applique 110 from conventional printed graphics. The raised and recessed features of the texture patterns provide physical depth that can be felt by touch, enhancing the perceived quality and realism of the graphic.

As shown in FIG. 6, the base layer 116 and multiple raised layers 118 of varying heights create a textured surface profile. Each photopolymer layer 116, 118 typically has a thickness between 14 and 30 microns, or in other examples a thickness between 25 and 100 microns, or in yet other examples a thickness between 50 and 200 microns, though other layer thicknesses may be employed depending on the printing system, print time constraints, and desired resolution. The interfaces 126 between successive layers are formed through the curing process, which bonds each newly deposited layer to the previously cured layer beneath it.

The photopolymer structure 112 may have a maximum height (shown in FIG. 6) ranging from 0.5mm to 5mm above the base layer 116. In some examples, the height H is between 1mm and 3mm, providing sufficient dimensional relief to create a noticeable tactile effect while maintaining structural integrity and durability during handling and application. Larger heights may be achieved for specialized applications, though heights exceeding 5mm may require additional support structures or modified application techniques.

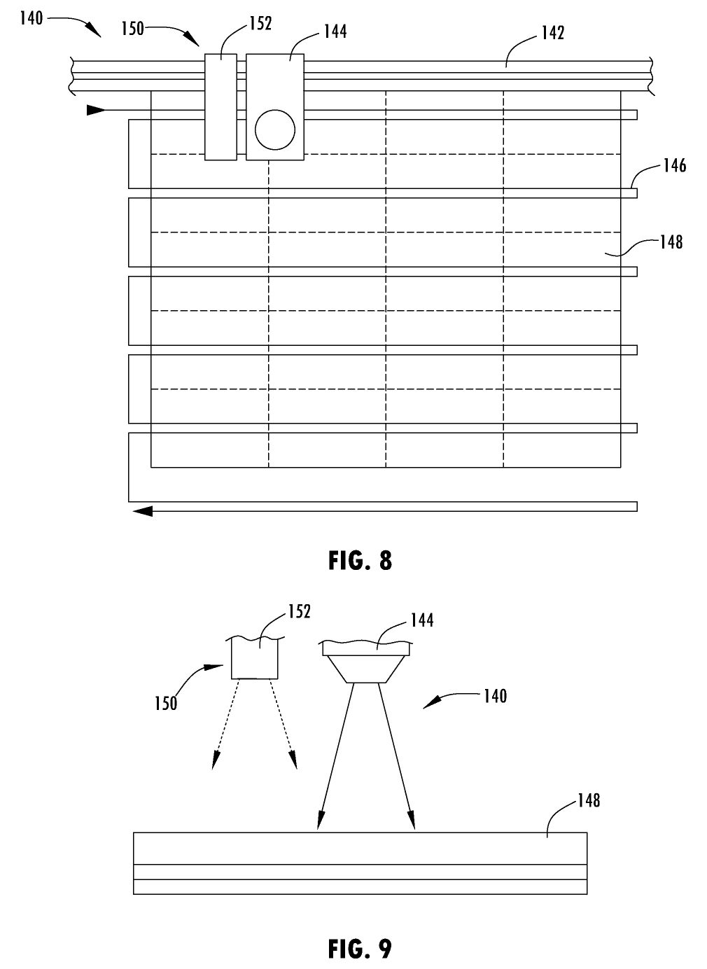

Referring again to FIGS. 3-6, the dimensional applique 110 has a substrate layer 120 disposed between the photopolymer structure 112 and the adhesive layer 114. The substrate layer 120 provides a carrier that supports the photopolymer structure 112 during manufacturing, handling, and application. As shown in FIGS. 5 and 6, the substrate layer 120 extends laterally beyond the edges of the photopolymer structure 112 and between the physically separated structural features (i.e., letters and design elements), so as to form an exposed outer surface 128 of the substrate layer 120. This exposed outer surface 128 can create an aspect of the visual effect of the dimensional applique 110 in combination with the photopolymer structure 112, such as to provide visible contrast to the colors of the photopolymer structure 112 and to form a visible border along the edges of the dimensional applique 110. The edge of the substrate layer 120 thereby forms the finished edge of the dimensional applique 110, which is shown as a cut edge. In other examples, the finished edge of the substrate layer may be a surged edge, a faced edge, a frayed edge, or a bound edge, among other conceivable finishes.

The substrate layer 120 may be selected from various materials, including polyester fabric, nylon fabric, cotton fabric, aramid fibers, rayon, polyethylene terephthalate (PET) film, polyurethane film, polyvinyl chloride (PVC) film, or blends of these materials. The selection of material for the substrate layer 120 depends on several factors, including the intended application, visible surface attributes, required flexibility, heat resistance, and compatibility with both the photopolymer structure 112 and the adhesive layer 114. For textile applications, such as garment decoration, a flexible fabric substrate, such as polyester or nylon fabric, is preferred. For hard surface applications, a polymer film substrate, such as PET or polyurethane film, may be more suitable.

As further shown in FIGS. 3-6, the adhesive layer 114 is disposed consistently and continuously over the entire lower surface of the substrate layer 120. For textile applications, like that shown in FIGS. 5 and 6, the adhesive layer 114 preferably comprises a thermally activated hot-melt adhesive. Thermally activated adhesives remain inactive at ambient temperatures and become tacky or molten when exposed to controlled heat, enabling a strong bond to textile fibers. Accordingly, the adhesive layer 114 may be partially embedded into the substrate layer 120 to form a mechanical and chemical bond at the interface with the substrate layer 120, such as shown in FIG. 6. The adhesive layer 114, as also shown in FIG. 6, is melted to embed and mechanically bond to the fabric at the target surface 104 of the garment 100. The adhesive layer 114 typically has a thickness between 25 microns and 250 microns, preferably between 50 microns and 150 microns. Thinner adhesive layers reduce overall applique thickness and stiffness, while thicker layers improve gap-filling capability and bond strength to textured or irregular textile surfaces. Specifically, the adhesive layer 114 is embedded into the target surface and intersperses into the fibers of the fabric garment. Suitable thermally activated adhesives include thermoplastic polyurethane (TPU), polyester-based hot-melt adhesives, polyolefin-based adhesives, polyamide-based adhesives, and copolyester adhesives. The adhesive layer 114 may comprise various adhesive formulations, depending on the intended application and target surface 104, such as pressure-sensitive adhesive for different applications, like hard or non-porous surfaces.

The adhesive layer 114, particularly when containing a thermally activated adhesive, is configured to activate at a threshold temperature. The adhesive is selected for the activation temperature to be below a degradation temperature of the cured photopolymer structure 112. This temperature relationship ensures that the adhesive layer 114 can be activated to bond the dimensional applique 110 to the target surface 104 without causing damage, distortion, or softening of the base layer 116 or raised layers 118 of the photopolymer structure 112. For example, if the cured photopolymer has a glass transition temperature of 50°C to 60°C and begins to soften or distort at temperatures above 80°C, the adhesive layer 114 should be formulated to activate at temperatures below 80°C for practical heat press applications.

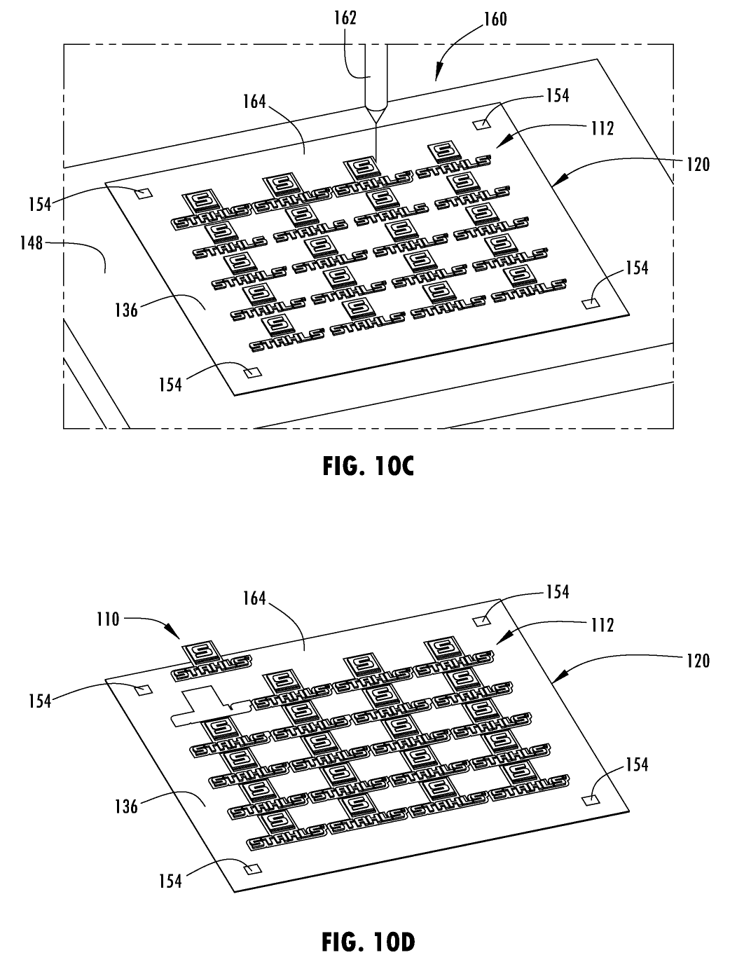

Referring now to FIGS. 7A and 7B, the substrate layer 120 is prepared with the adhesive layer 114 before the printing process begins. Several alternative methods for substrate preparation are contemplated, each offering different advantages depending on production requirements and adhesive type. As shown in FIGS. 7A and 7B, a preparation method involves laminating a pre-formed adhesive material onto a substrate material in roll form, then converting the laminated material into sheets, such as with a cutter or die. As shown in FIG. 7A, an adhesive roll 130 containing adhesive film is unwound and brought into contact with a substrate roll 132 containing substrate material. The two materials pass through a lamination system comprising heated rollers that apply heat and pressure to bond the adhesive film to the substrate material, creating a laminated roll 134.

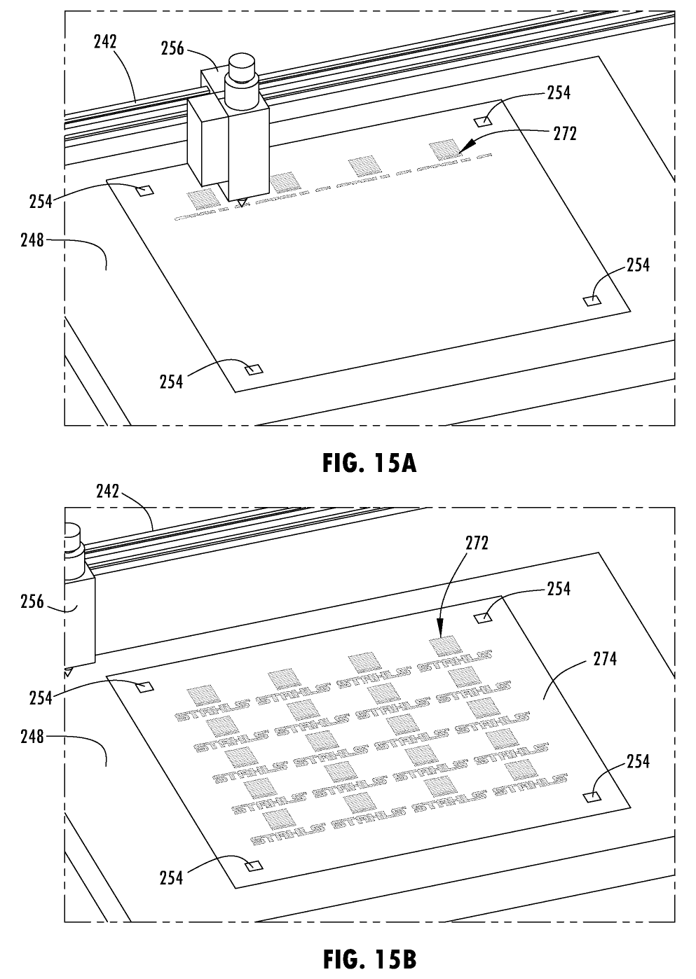

As shown in FIG. 7B, the laminated roll 134 is then fed into a sheeting system that precisely cuts the laminated material into individual sheets 136 dimensioned to fit the print bed 148 of the printing system, such as shown in FIGS. 10A-10D. The sheets 136 each have the adhesive layer 114 disposed along the entirety of the underside of the substrate layer 120. This roll-to-sheet process enables efficient, high-volume production of print-ready substrate sheets with consistent adhesive coverage.

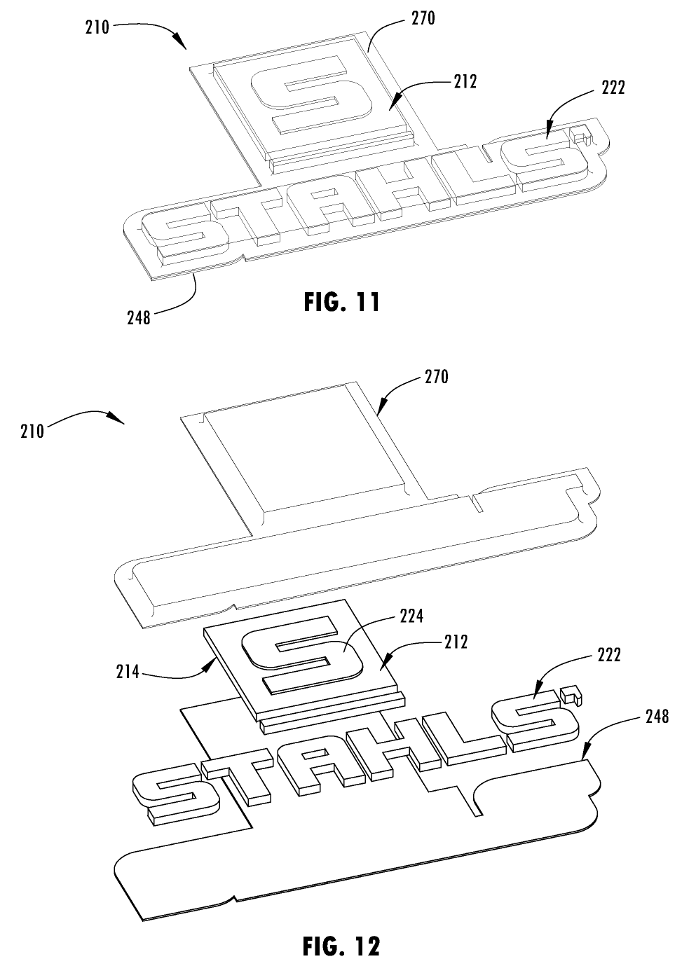

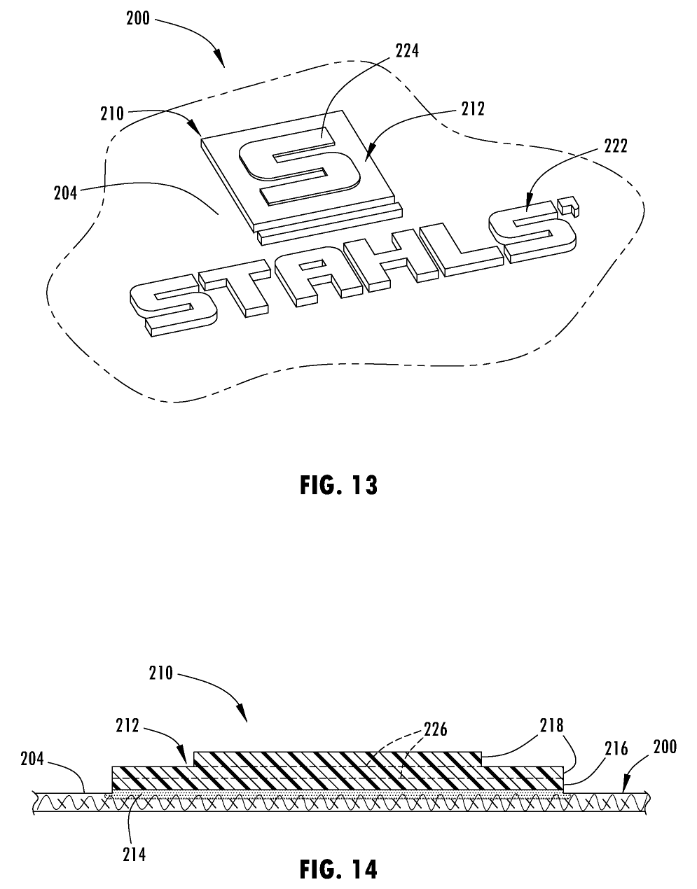

The apparatus for producing the dimensional applique 110 includes a printing system 140, such as shown in FIGS. 8 and 9, that may be integrated together in a coordinated manufacturing workflow with an ultraviolet curing system 150, a cutting system 160, and a material handling system. The printing system 140 is configured to deposit liquid photopolymer material over a prepared adhesive layer disposed on a print bed 148 in successive layers to form the three-dimensional photopolymer structure 112. As shown in FIGS. 8 and 9, the printing system 140 includes a gantry framework 142 supporting one or more print heads 144. The print heads 144 move in a raster pattern 146 across the print bed 148, shown schematically in FIG. 9, depositing droplets of liquid photopolymer material in precise locations according to digital model data. Multiple types and colors of photopolymer material may be simultaneously or asynchronously deposited from a single print head 144. For example, each print head 144 may contain a plurality of nozzles that eject droplets of liquid photopolymer. Each nozzle may eject droplets with volumes between 1 and 100 picoliters, and more commonly between 5 and 30 picoliters. The small droplet size enables high-resolution printing with fine feature detail.

Different colors and properties may be deposited in a single layer, which are then blended at their interfaces to create smooth color transitions. The deposition of different photopolymer materials within a single print cycle enables the creation of full-color gradients and varying material properties. In some examples, multiple print heads may be mounted on the gantry framework. In these examples, each print head may be dedicated to a specific photopolymer material, such as a print head that deposits cyan photopolymer, a print head that deposits magenta photopolymer, a print head that deposits yellow photopolymer, a print head that deposits black photopolymer, and a print head that deposits white or clear photopolymer. Additional print heads may be provided for support material, flexible elastomeric photopolymer, or other specialized materials.

As also shown in FIGS. 8 and 9, the ultraviolet curing system 150 is positioned adjacent to the print head 144 and configured to expose deposited liquid photopolymer material to ultraviolet light immediately after deposition. The ultraviolet curing system 150 may include one or more UV lamps 152 with associated reflectors and optics that direct UV light onto the deposited material. The UV lamps 152 may comprise mercury vapor lamps, LED-based UV sources, or other ultraviolet light sources with appropriate wavelength and intensity for curing the photopolymer formulations being used. As each layer is deposited and cured, it solidifies and provides a stable base for the next layer. This enables the buildup of three-dimensional structures with fine details and varying heights without sagging or flow of uncured material. The curing process also bonds each new layer to the previously cured layer, creating a monolithic structure.

Referring now to FIGS. 10A-10D, the print-ready substrate sheet 136 is loaded into the printing system 140 positioned on the print bed 148. The printing system 140 may incorporate or be integrated with a substrate handling system, which may include a hold-down platform for maintaining the position of the substrate sheet 136 during printing and any subsequent cutting operations. In one example, the hold-down platform is a vacuum hold-down platform. The vacuum hold-down platform may include a perforated or porous surface connected to vacuum channels that communicate with a vacuum source. When vacuum is applied, suction forces secure the substrate against the platform surface defining the print bed 148, thereby preventing movement, wrinkling, or lifting during the printing process. In another example, the hold-down platform may be an adhesion hold-down platform. The adhesion platform, which may be referred to as a tacky platform or bed, may include an upper surface with a reusable adhesive that removably secures the substrate to the platform surface defining the print bed 148 with sufficient adhesion to prevent movement, wrinkling, or lifting during the printing process while still allowing subsequent removal of the substrate from the platform surface.

The printing system 140 may also incorporate or be integrated with an optical registration system having optical sensors, such as a camera, configured to detect the positioning of the substrate sheet 136. The optical sensors may detect fiducial marks 154, substrate edges, or other alignment features to verify proper substrate placement. Based on sensor feedback and the type of hold-down platform (e.g., vacuum or adhesion hold-down), the system may adjust vacuum hold-down force, trigger alignment corrections, or alert to substrate positioning errors. In some examples, the registration fiducials 154 are printed as raised structures at the corners of the substrate sheet 136, such as each registration fiducial 154 being a raised square structure printed in black photopolymer for high contrast and easy detection. Other fiducial geometries, sizes, colors, and heights may be used depending on the capabilities of the optical registration system.

As shown in FIG. 10A, the printing system 140 proceeds layer by layer, with the print heads 144 depositing liquid photopolymer material in controlled patterns and the UV curing system 152 immediately curing each deposited layer. Initially, as shown in FIG. 10A, the base layer 116 is deposited onto the substrate sheet 136, and then subsequent raised layers 118 are deposited onto the base layer 116. The printing operation continues until all the photopolymer structures 112 for each appliques are completed, resulting in a substrate sheet with multiple printed structures. For example, as shown in FIG. 10B, the substrate sheet 120 has all photopolymer structures 112 formed at appropriate locations after three-dimensional printing and curing processes are complete.

An advantage of the disclosed system and method is the ability to produce multiple dimensional appliques in a single print cycle through batch production. A nested arrangement of multiple dimensional applique designs may be arranged over the substrate sheet 136 to maximize utilization of the available print area. In the illustrated embodiment, twenty individual appliques are nested on a single substrate sheet. However, depending on the size of the individual appliques, a single print cycle may produce more or fewer, such as 20, 50, 100, or more dimensional appliques. The nesting arrangement is determined based on multiple variables including the number of appliques desired, the size and shape of each applique design, the dimensions of the print bed 148, the number and configuration of print heads 144, and the spacing required between appliques to accommodate cutting operations. Nesting software optimizes the arrangement to fit as many appliques as possible while maintaining adequate spacing and accounting for registration fiducials 154. The nested print file may be loaded into the printing system control software, which may divide the model into layers and generates print head motion commands.

As shown in FIGS. 10C and 10D, the substrate sheet 136 is loaded into the cutting system 160, which in some examples may be the same print bed 148 to avoid movement to a different station. Accordingly, the cutting system 160 may be integrated with the printing system 140 in some implementations. A digital file, referred to as a nested cut file, may be provided that is loaded into the control software of the cutting system 160. Like the print system, an optical registration system may be integrated into the cutting system 160 to capture images of the substrate sheet and detect the registration fiducials 154. The registration fiducials 154 may be printed as part of the three-dimensional structure during the printing process. Image processing software calculates position corrections of the substrate sheet 136 based on the detected fiducial locations, accounting for any translation, rotation, scaling, or distortion of the substrate. Also, by detecting multiple fiducials, the system can calculate any translation, rotation, or scaling corrections needed to align the cutting paths with the actual printed structures.

As also shown in FIG. 10C, the cutting system 160 includes a cutting tool 162, illustrated as a laser cutter, such as a CO₂ laser having a power output between 40 and 150 watts. In additional examples, the cutting tool may be a blade cutter with a controlled cutting blade moved along cutting paths by actuators. The cutting tool 162 is aligned with a cut path or contour based on the detected fiducial positions. For laser cutting, multiple passes may be employed to ensure complete separation without excessive heat accumulation that could distort the photopolymer structure. For blade cutting, a drag knife or oscillating blade with a controlled depth setting cuts through the substrate layer while leaving the release liner or carrier intact. The cut contour defines the boundary or edge of the dimensional applique 110, separating it from the surrounding waste matrix 164. The cutting system 160 may adjust the cutting path based on the position corrections calculated from the fiducial detection, ensuring accurate separation even if the substrate 136 has shifted, stretched, or distorted during handling between the printing and cutting operations.

As further shown in FIG. 10C, the cutting system 160 proceeds with the cutting tool 162 following the adjusted cut paths, separating individual dimensional appliques 110 from the surrounding waste matrix 164. After cutting, the individual dimensional appliques 110 are separated by cut lines 166. The waste matrix 164 surrounding each applique remains attached to the substrate 136. As shown in FIG. 10D, the individual dimensional appliques 110 are removed from the waste matrix 164, which may be referred to as being weeded. The completed dimensional appliques 110 are then ready for application to target surfaces, which may occur immediately or at a later time. The appliques may be stored, packaged, and shipped to customers or application facilities.

It is also contemplated that in some examples, the dimensional applique is removed from the print bed without requiring a cutting operation. This is possible when the applique design does not include disconnected elements and the print bed has been prepared such that the photopolymer structure adheres sufficiently during printing but can be cleanly removed afterward. For example, when adhesive is selectively applied only in discrete areas corresponding to applique shapes and the photopolymer structure is printed entirely within those adhesive areas, the completed applique may be peeled or lifted without cutting. The areas of substrate surrounding the applique do not have adhesive or photopolymer material, so no bond exists beyond the intended applique boundary. Similarly, when using a release-coated carrier with selective adhesive application, individual appliques may be removable by simply peeling them from the carrier after printing, eliminating the need for the cutting system and associated registration fiducials.

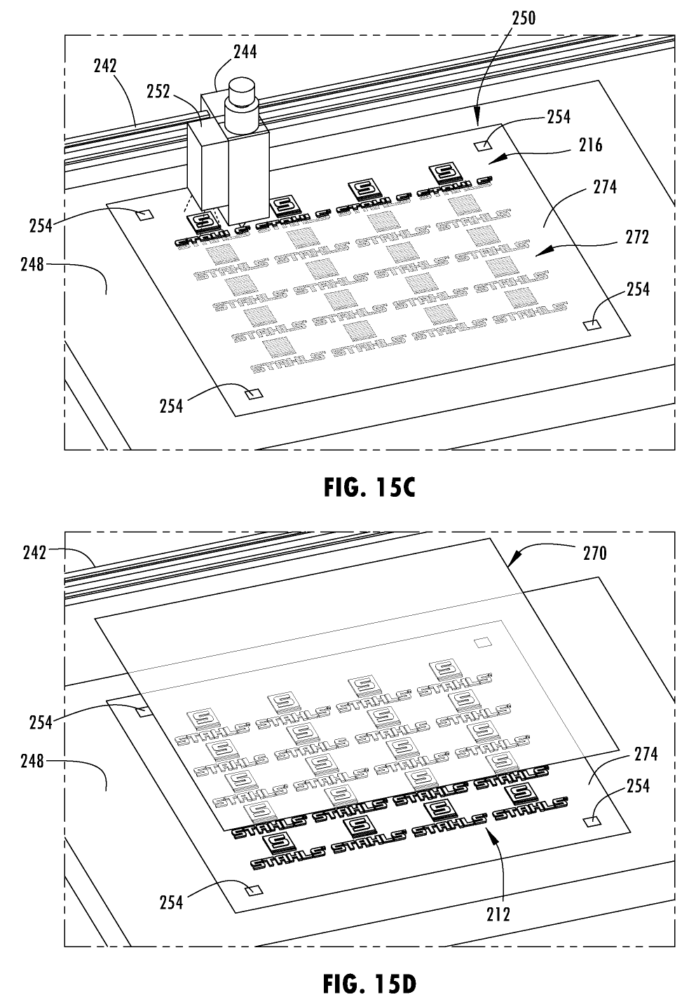

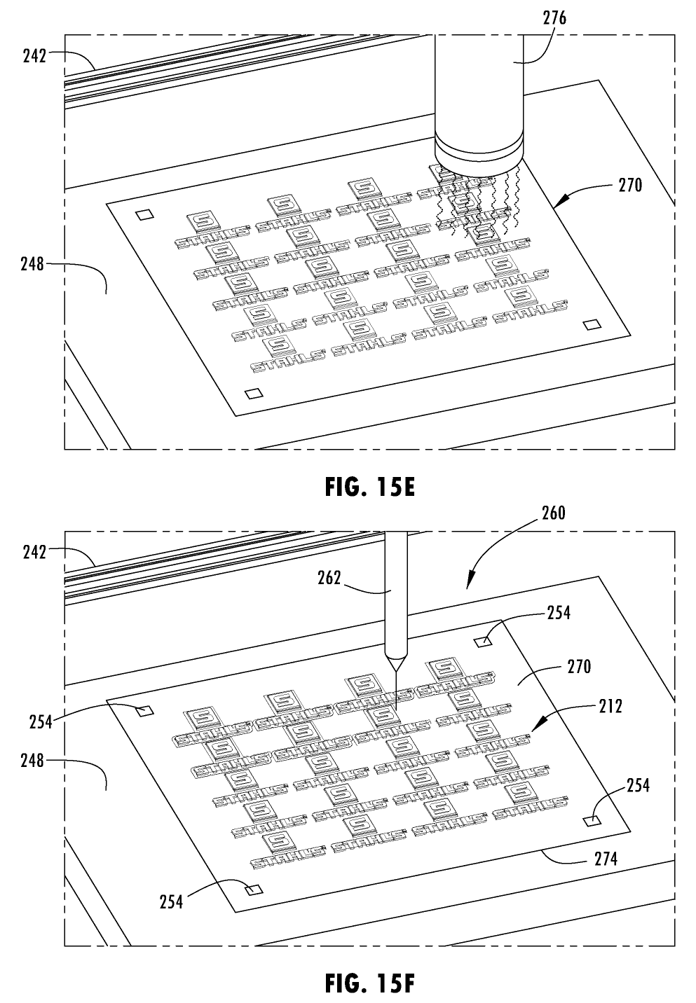

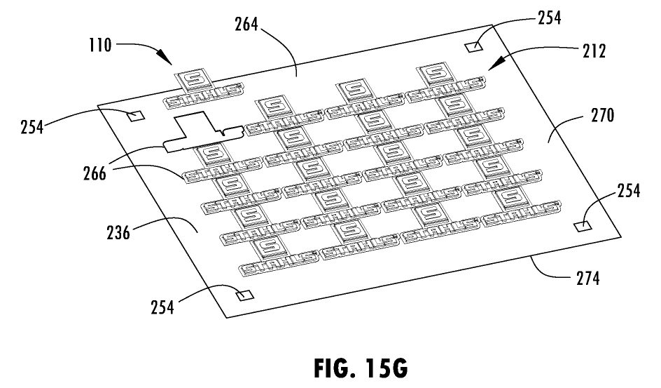

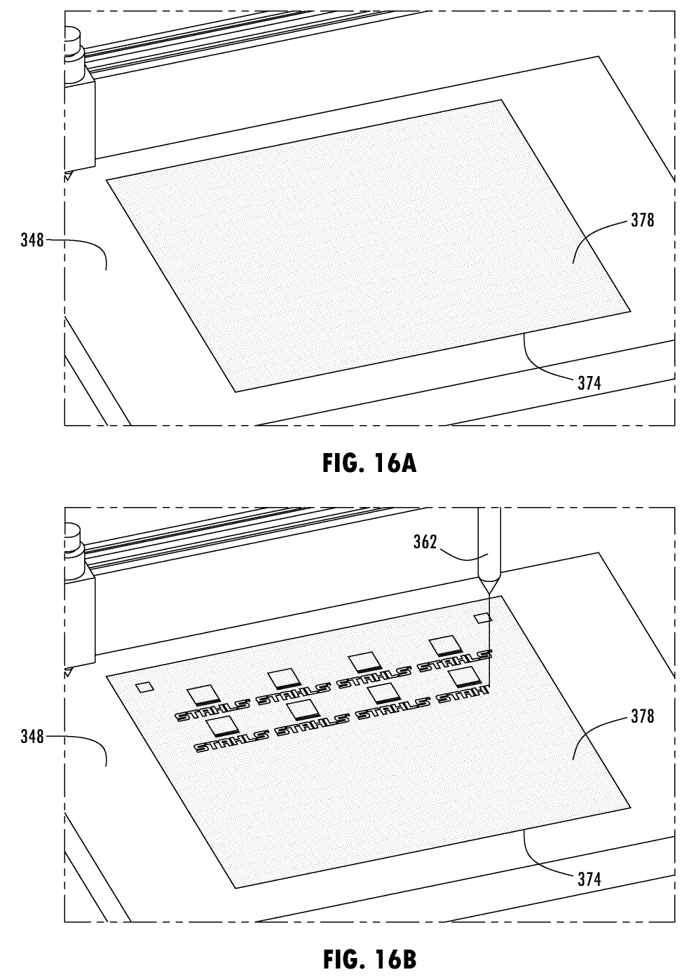

Referring now to FIGS. 11-14, an alternative example of the dimensional applique 210 has the photopolymeric structure 212 applied directly to the adhesive layer 214, without an intermediate fabric substrate layer. This dimensional applique 210 is also shown in FIG. 2 applied to the shirt 200. This arrangement is advantageous when a substrate layer is not required for the final application, or when minimizing the overall thickness of the dimensional applique 210 is desired. The elimination of the substrate layer also reduces material costs and may improve the conformability of the dimensional applique 210 to curved or irregular target surfaces, such as loose garments or textiles. Again, in the examples shown in FIGS. 11-14, the printed image 222 displays a logo with the text "STAHLS" incorporating multiple colors, dimensional lettering, and raised surface features. Specifically, in the illustrated example shown in FIG. 14, the letter "S" is raised from the surrounding layers, forming the outermost layer of the raised layers 218 that protrudes from the base layer 216. The outer surface 224 of the letter "S" is distinct from the surrounding outer surfaces 224, providing added visibility.

Without the substrate layer, the materials of the photopolymeric structure 212 and the adhesive layer 214 are selected to provide a bonded interface therebetween, while maintaining the adhesive properties of the adhesive layer 214 and the full-color gradients and texture variation of the photopolymer structure 212. The photopolymer structure 212 is formed from one or more liquid photopolymer materials that are deposited in controlled patterns and cured using ultraviolet light. The photopolymer materials may include rigid photopolymers, flexible elastomeric photopolymers, transparent photopolymers, and pigmented photopolymers in various colors. The photopolymer structure 212 may also include regions of different material hardness and flexibility within a single printed object. The adhesive layer 214 is shown as a thermally activated hot-melt adhesive that is melted to embed and mechanically bond to the fabric at the target surface 204 of the garment 200. Specifically, the adhesive layer 214 is embedded into the target surface and intersperses into the fibers of the fabric garment.

As shown in FIGS. 11-14, the dimensional applique design 210 has disconnected elements that are spatially separated within the overall design. The disconnected elements are shown as separate letters, symbols, and graphic elements, which must maintain precise spatial relationships but are not physically connected. When producing dimensional appliques with disconnected elements, an application mask 270 may be used to maintain the proper spatial relationships during application. The application mask 270 is positioned over the printed dimensional applique elements while they are still on the print bed or a releasable substrate. The mask 270 adheres lightly to the photopolymer structures 212. The mask 270 with attached elements is then positioned on the target surface 204, and the adhesive is activated (by heat or pressure, depending on the adhesive type). After bonding is complete, the mask 270 is removed, leaving the disconnected elements properly positioned and bonded to the target surface 204.

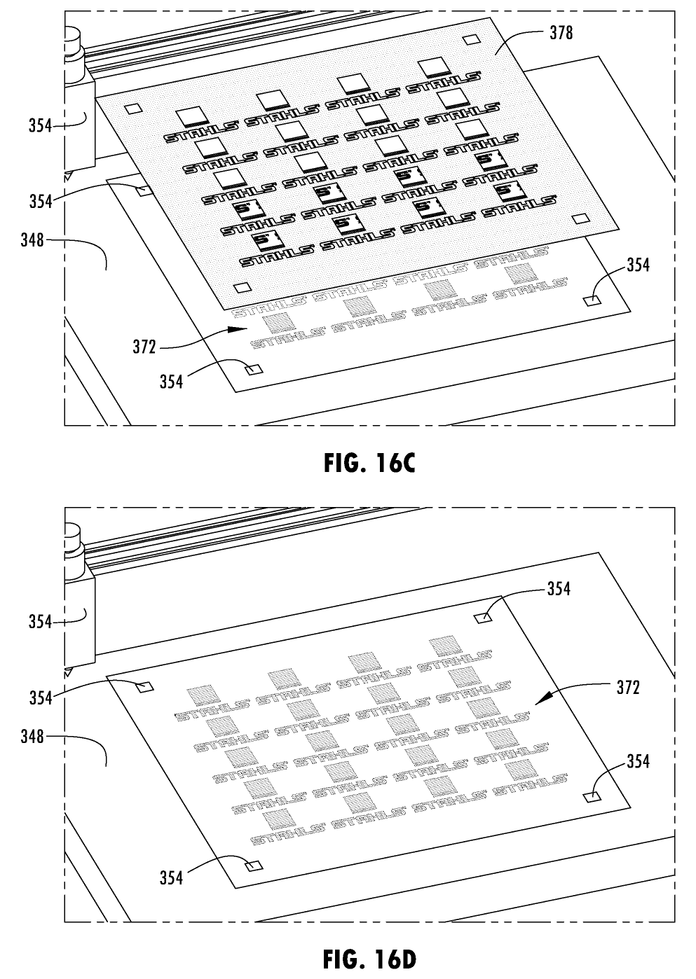

The production process for the dimensional applique 210 is depicted, for example, in FIGS. 15A-15G. As shown in FIGS. 15A and 15B, an alternative substrate preparation method is provided in which adhesive 272 is selectively applied only in regions corresponding to planned applique locations. In some examples, a release-coated carrier 274 is loaded onto an adhesive application system. The release-coated carrier 274, as shown in FIGS. 15A-15D, serves as a temporary support during manufacturing, handling, and shipping, but is removed before application. The release coating on the carrier 274 may comprise silicone-based release agents that provide low adhesion to the adhesive layer 214, allowing the carrier 274 to be peeled away cleanly without leaving residue or damaging the dimensional applique 210. The printing system may incorporate or be integrated with a substrate handling system and/or an optical registration system configured to detect the positioning of the carrier 274, such as the fiducial marks 254 printed at the corners of the sheet forming the carrier 274.

The adhesive application system may be integrated into a printing system, such that the release-coated carrier 274 may be loaded into the print bed 248 and a dedicated adhesive printing head 256 may be provided that is capable of depositing adhesive over the print bed 248 in patterns. As shown in FIG. 15A, adhesive material 272 is deposited onto the carrier 274 in discrete areas corresponding to the locations where photopolymer structures will be printed (shown in FIG. 15D). This selective application of adhesive 272 reduces material waste and cost, as adhesive is only applied where it will be used in the final applique. The patterned adhesive 272 may be printed in the exact shape of each photopolymer structure 212 or may be printed in slightly undersized areas to reduce adhesive visibility upon application or may be printed in slightly oversized areas that will later be trimmed during the cutting operation.

As shown in FIGS. 15C and 15D, the printing system proceeds layer by layer, with the print head 244 depositing liquid photopolymer material in controlled patterns and the UV curing system 252 immediately curing each deposited layer. Initially, as shown in FIG. 15C, the base layer 216 is deposited onto the carrier 274, and then subsequent raised layers 218 are deposited onto the base layer 216. The printing operation continues until all the photopolymer structures 212 for each applique are completed, resulting in a carrier sheet with multiple printed structures. For example, as shown in FIG. 15D, the substrate sheet 210 has all photopolymer structures 212 formed at appropriate locations after three-dimensional printing and curing processes are complete.

Once all the photopolymer structures 212 are printed, an application mask 270 is applied over the printed elements, such as shown in FIG. 15D. The mask 270, as shown in FIGS. 15E, is adhered to the upper surfaces of the photopolymer structures 212 by heating the mask 270, such as with a heat gun 276, so that it shrinks and melts over the photopolymer structures 212. For disconnected element designs, the cutting operation is typically required to separate the individual elements from the waste matrix 264 while maintaining them on the carrier 274 or mask 270 for subsequently being applied onto garments.

As shown in FIGS. 15F and 15G, the photopolymer structures 212 secured by the mask sheet 270 and/or the carrier sheet 274 are loaded into the cutting system 260, which in some examples may be the same print bed 248 to avoid movement to a different station. Accordingly, the cutting system 260 may be integrated with the printing system 250. The nested cut file may be loaded into the control software of the cutting system 260. Like the print system, an optical registration system may be integrated into the cutting system 260 to capture images of the substrate sheet and detect the registration fiducials 254. The registration fiducials 254 may be printed as part of the three-dimensional structure during the printing process and/or adhesive printing process. Image processing software calculates position corrections of the mask sheet 270 and/or the carrier sheet 274 based on the detected fiducial locations, accounting for any translation, rotation, scaling, or distortion of the sheets. Also, by detecting multiple fiducials, the system can calculate any translation, rotation, or scaling corrections needed to align the cutting paths with the actual printed structures.

As further shown in FIG. 15F, the cutting system 260 includes a cutting tool 262, illustrated as a laser cutter that is aligned with a cut path or contour based on the detected fiducial positions. The cut contour defines the boundary or edge of the dimensional applique 210, separating it from the surrounding waste matrix 264. The cutting system 260 proceeds with the cutting tool 262 following the adjusted cut paths, separating individual appliques 210 from the surrounding waste matrix 264. After cutting, the individual dimensional appliques 210 are separated by cut lines 266. As shown in FIG. 15G, the individual dimensional appliques 210 are removed from the waste matrix 264, which may be referred to as weeding. The completed dimensional appliques 210 are then ready for application to target surfaces, which may occur immediately or at a later time. The appliques may be stored, packaged, and shipped to customers or application facilities.

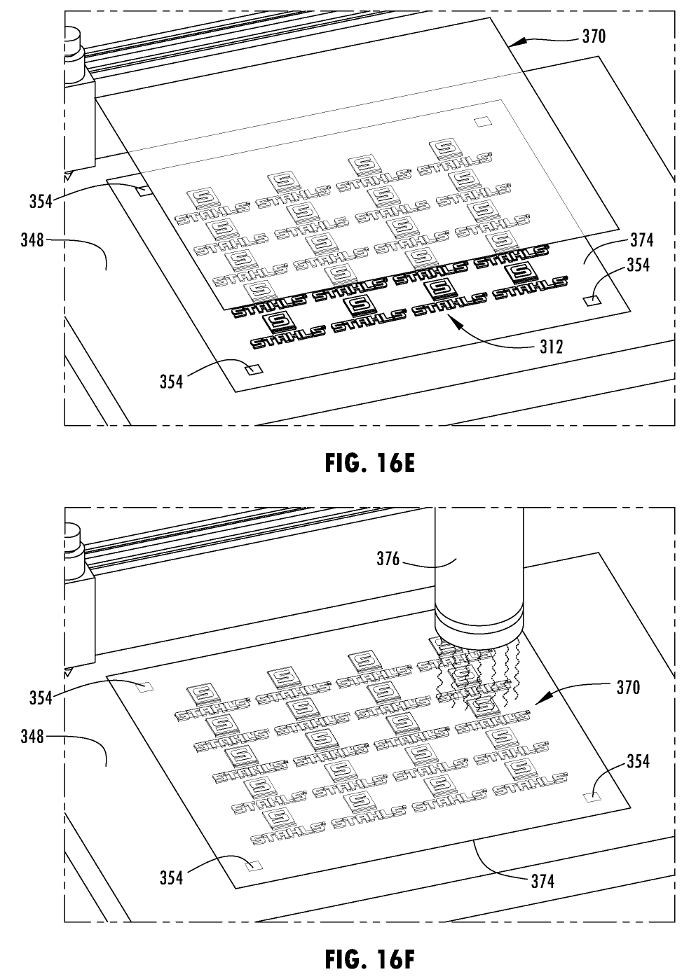

Referring now to FIGS. 16A-16D, another alternative substrate preparation method is provided, in which an adhesive sheet 378 is precisely cut and weeded to leave adhesive pieces only in the areas corresponding to the applique designs. The adhesive sheet 378 may be laminated over a carrier 374, as shown in FIG. 16C, and in additional examples may be loaded directly onto the print bed without a carrier. The carrier 374 is covered by a consistent and continuous adhesive sheet 378. A cutting tool 362, such as a laser cutter or blade cutter, cuts the adhesive layer in patterns corresponding to the planned applique designs, such as shown in FIG. 16B. The cutting depth is controlled to penetrate through the adhesive layer without cutting through the underlying carrier or substrate. After cutting, the remaining portion of the adhesive sheet 378 may be weeded or removed, as shown in FIG. 16C, leaving adhesive material 372 arranged in discrete areas corresponding to the locations where photopolymer structures will be printed (shown in FIG. 16D). The printing system then proceeds layer by layer, with the print head depositing liquid photopolymer material in controlled patterns and the UV curing system immediately curing each deposited layer. The printing operation continues until all the photopolymer structures 312 for each applique are completed, resulting in a carrier sheet with multiple printed structures.

As shown in FIGS. 16F-16H, once all the photopolymer structures 312 are printed, an application mask 370 is applied over the printed elements. The mask 370 is adhered to the upper surfaces of the photopolymer structures 312 by heating the mask 370, such as with a heat gun 376, so that it shrinks and melts over the photopolymer structures 312. The photopolymer structures 312 secured by the mask sheet 370 and/or the carrier sheet 374 are loaded into the cutting system 360, which in some examples may be the same print bed 348 to avoid movement to a different station. The cutting system 360 may be integrated with the printing system 350, where the cutting system 360 includes a cutting tool 362, illustrated as a laser cutter that is aligned with a cut path or contour based on the detected fiducial positions. The cut contour defines the boundary or edge of the dimensional applique 310, separating it from the surrounding waste matrix 364. The cutting system 360 proceeds with the cutting tool 362 following the adjusted cut paths, separating individual appliques 310 from the surrounding waste matrix 364. After cutting, the individual dimensional appliques 310 are separated by cut lines 366. As shown in FIG. 16H, the individual dimensional appliques 310 are removed from the waste matrix 364, which may be referred to as weeding. The completed dimensional appliques 310 are then ready for application to target surfaces, which may occur immediately or at a later time. The appliques may be stored, packaged, and shipped to customers or application facilities.

Each of the substrate preparation methods shown and described herein may be selected based on factors including production volume, adhesive type, applique design complexity, and equipment availability. The lamination method (FIGS. 7A-7B) is well-suited for high-volume production with continuous adhesive coverage. The selective adhesive application method (FIGS. 15A-15B) minimizes adhesive waste and is advantageous when adhesive cost is a significant factor. The cut-and-weed method (FIGS. 16A-16B) offers precise adhesive placement and may be preferred for complex applique geometries or when using specialty adhesive materials. After the photopolymer structures are printed and cured, individual appliques may be cut and removed from the carrier, or in some cases may be self-releasing and removable without cutting.

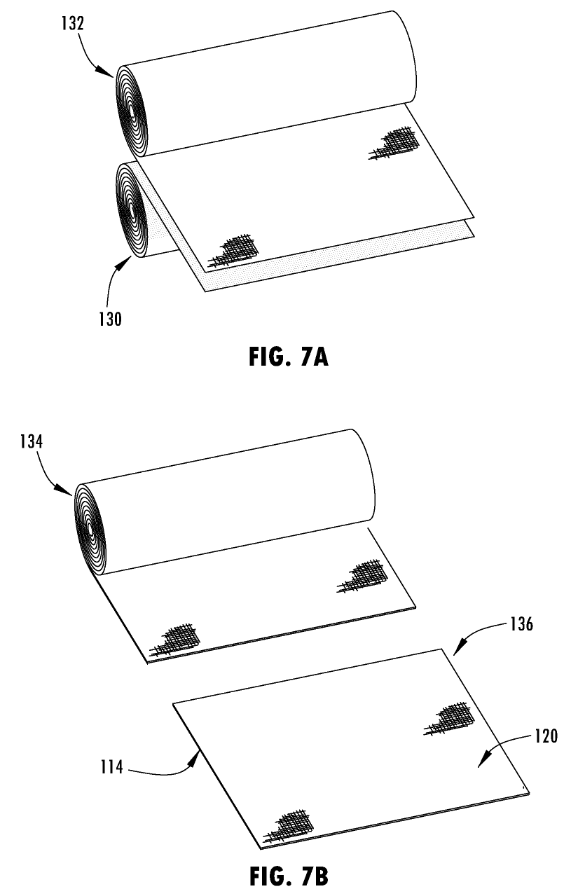

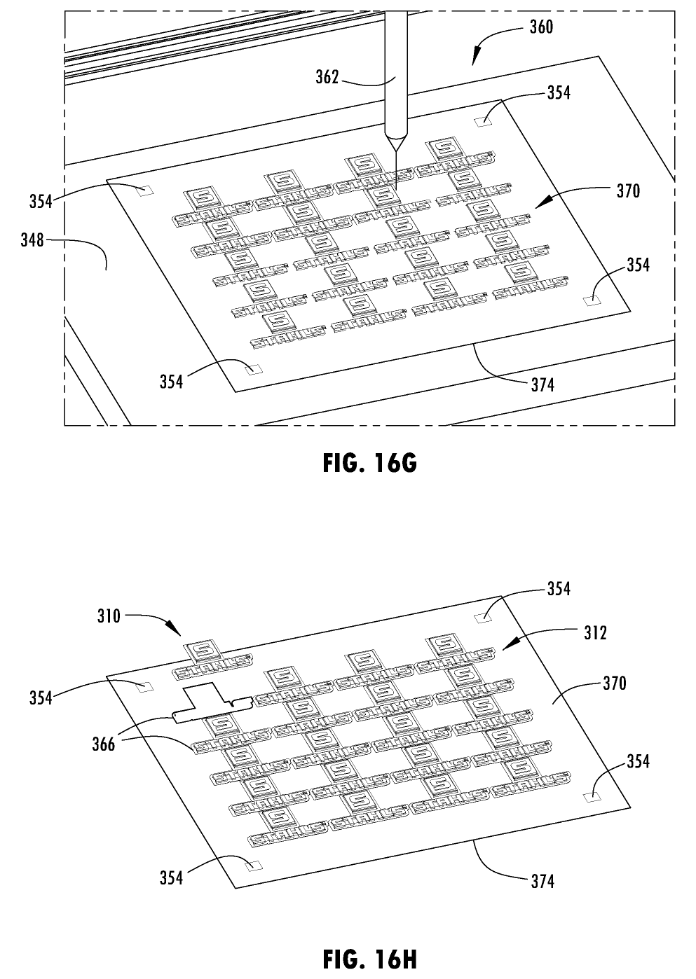

Referring now to FIGS. 17A and 17B, the application of a dimensional applique 410 similar to the example shown in FIGS. 3 and 4 is applied to a textile target surface 404 using a heat press with a thermally activated adhesive layer 414. FIG. 17B shows a heat press apparatus 480 configured with bottom heating. The heat press apparatus 480 includes a heated lower platen 482 and an unheated upper platen 484 that can be closed together to apply pressure. The heated lower platen 482 incorporates heating elements that heat the platen surface to a controlled temperature. A temperature controller regulates the platen temperature based on feedback from temperature sensors. The upper platen 484 may be mounted on a frame with a handle or a pneumatic/hydraulic actuator for opening and closing the press.

As shown in FIG. 17A, the textile target surface 404 of a garment 400 is positioned on the heated lower platen 482. The dimensional applique 410 is positioned on the textile surface 404 with the adhesive layer 414 in contact with the textile fibers and the photopolymer structure 412 facing upward toward the upper platen 484. A pressure distribution pad 486 is placed over the dimensional applique 410. The pressure distribution pad 486 enables successful application of dimensional appliques with varying surface heights. The pressure distribution pad 486 is typically formed from a resilient material such as foam rubber, silicone foam, polyurethane foam, or other compressible materials. The thickness of the pressure distribution pad 486 is selected based on the maximum height of the photopolymer structure 412 and is typically between 3mm and 15mm. The durometer is selected to provide sufficient softness to conform around raised features while maintaining enough firmness to transmit pressure. The compressibility of the pressure distribution pad 486 enables it to deform around the varying heights of the raised layers 418 of the photopolymer structure 412. As shown in FIG. 17B, the pad 486 compresses more in areas where the photopolymer structure has greater height and less in areas of lower height, thereby distributing pressure more evenly across the adhesive layer 414.

As also shown in FIG. 17B, the upper platen 484 is closed, applying pressure to the assembly. The heated lower platen 482 heats the textile 400, which in turn heats the adhesive layer 114. The heat flows from the bottom through the textile and directly to the adhesive layer 414, rather than from the top through the photopolymer structure 412. This bottom-heating approach is to activate the adhesive layer 414 while minimizing heat exposure to the photopolymer structure 412. The photopolymer structure 412 is also insulated by the pressure distribution pad 486 and is not in direct contact with a heated platen to reduce the risk of distortion, softening, or surface damage to the outer surface of the raised layers 418.

After the dwell time is complete, the upper platen 484 is opened and the assembly is allowed to cool. The adhesive layer 414 has melted and flowed into the textile fibers during heating, and has resolidified upon cooling, creating a strong chemical and mechanical bond. If a mask was present, it may be removed after bonding by being peeled away from the photopolymer structure. The bonded dimensional applique provides a durable, washable graphic with dimensional relief and full-color detail. The bond between the adhesive layer and the textile is sufficiently strong to withstand repeated washing, wearing, and mechanical stress while maintaining the integrity of the photopolymer structure.

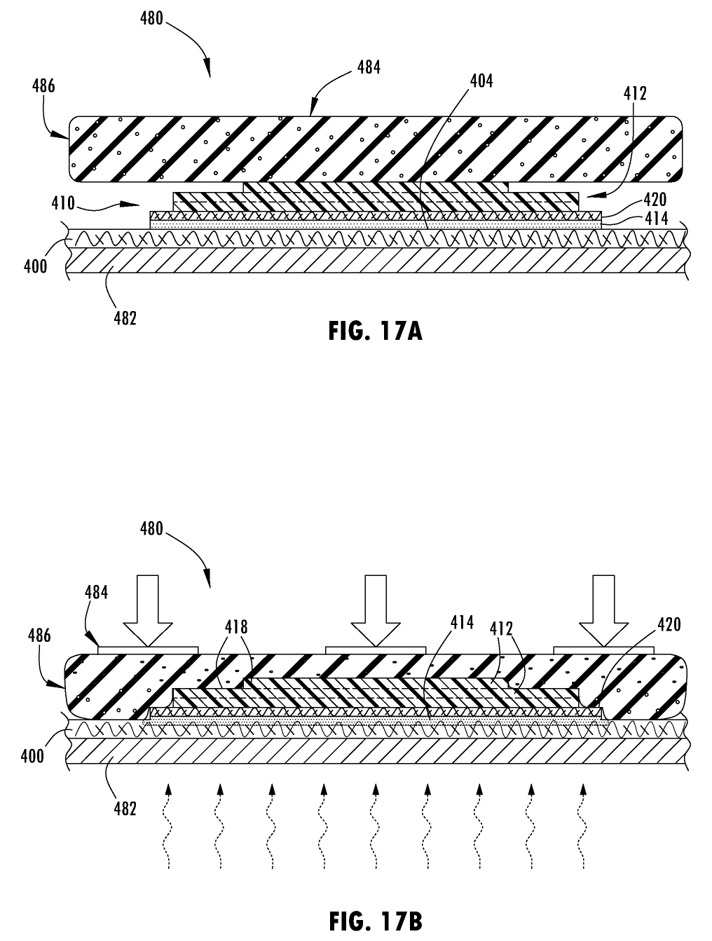

As shown in FIGS. 18A and 18B, an example of the dimensional applique 510 is provided with a pressure-sensitive adhesive layer 514 configured for application to hard surfaces. Hard surfaces may include plastics, metals, glass, ceramic, wood, painted surfaces, or other rigid or semi-rigid substrates. Pressure-sensitive adhesives form a bond when pressure is applied, without requiring heat activation. Suitable pressure-sensitive adhesives include acrylate-based adhesives, rubber-based adhesives (natural or synthetic), silicone adhesives, and hybrid pressure-sensitive adhesives combining properties of different adhesive chemistries.

The dimensional applique 510, as shown in FIG. 18A, is positioned over the hard target surface 504 of a hard good 500. The dimensional applique 510 in this embodiment includes the photopolymer structure 512 and the pressure-sensitive adhesive layer 514. Before application, a release liner protecting the adhesive layer 514 may be removed, exposing the tacky adhesive surface. The target surface 504 is preferably cleaned before application to remove dust, oils, or contaminants that might interfere with adhesion. Cleaning may be performed using isopropyl alcohol, soapy water, or other appropriate cleaning agents followed by drying.

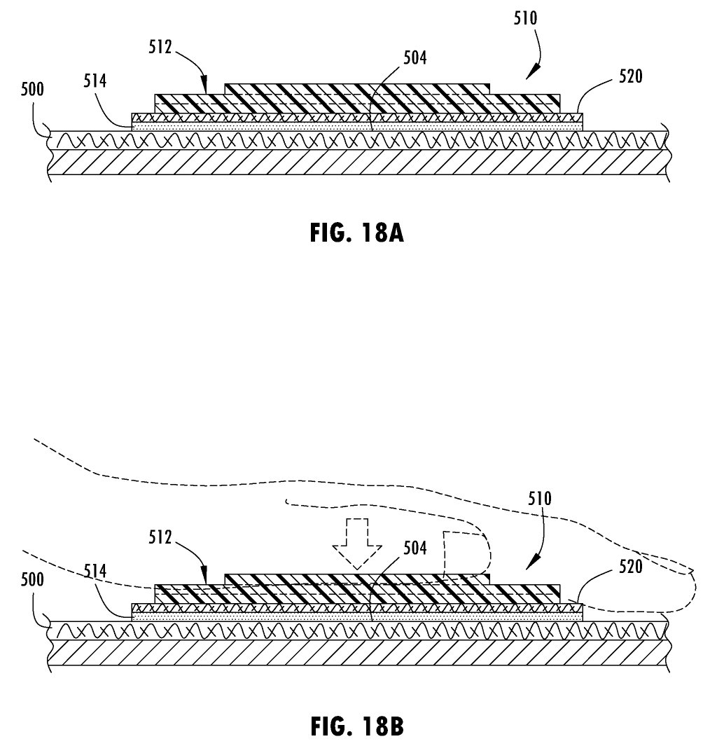

As shown in FIG. 18B, the pressure-sensitive adhesive layer 514 is in contact with the hard target surface 504. The dimensional applique 510 is positioned carefully to achieve the desired placement and orientation. Once the adhesive contacts the surface, repositioning becomes difficult or impossible, depending on the adhesive formulation. Pressure is then applied to the dimensional applique 510 to activate the pressure-sensitive adhesive 514 and promote bonding. Pressure may be applied manually, as shown, by pressing firmly with hands, or may be applied using a mechanical press or roller. FIGS. 19A-19B illustrate an alternative application method using a press 680 with platens 682, 684 that compress the dimensional applique 610 against the target surface 604.

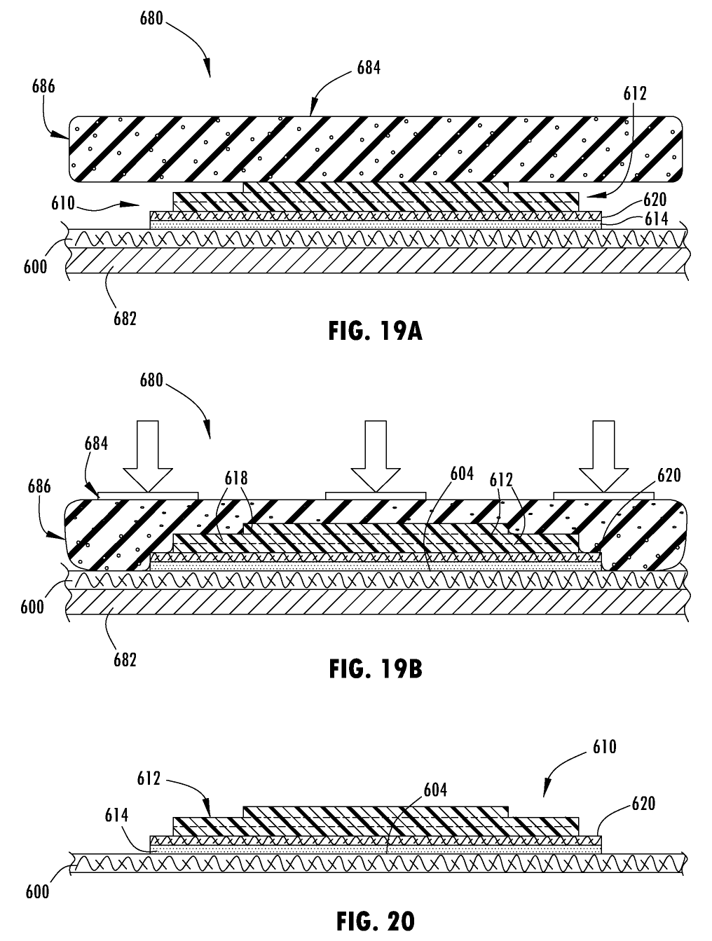

FIG. 20 shows the dimensional applique 610 bonded to the hard target surface 600 after pressure application. The mask, if present, may be removed after bonding. The pressure-sensitive adhesive 614 layer forms a strong bond to the target surface 604 through molecular interactions and mechanical interlocking with surface irregularities. The dimensional applique 610 applied to hard surfaces provides durable, weather-resistant branding and decoration suitable for outdoor applications, product labeling, signage, and promotional items.

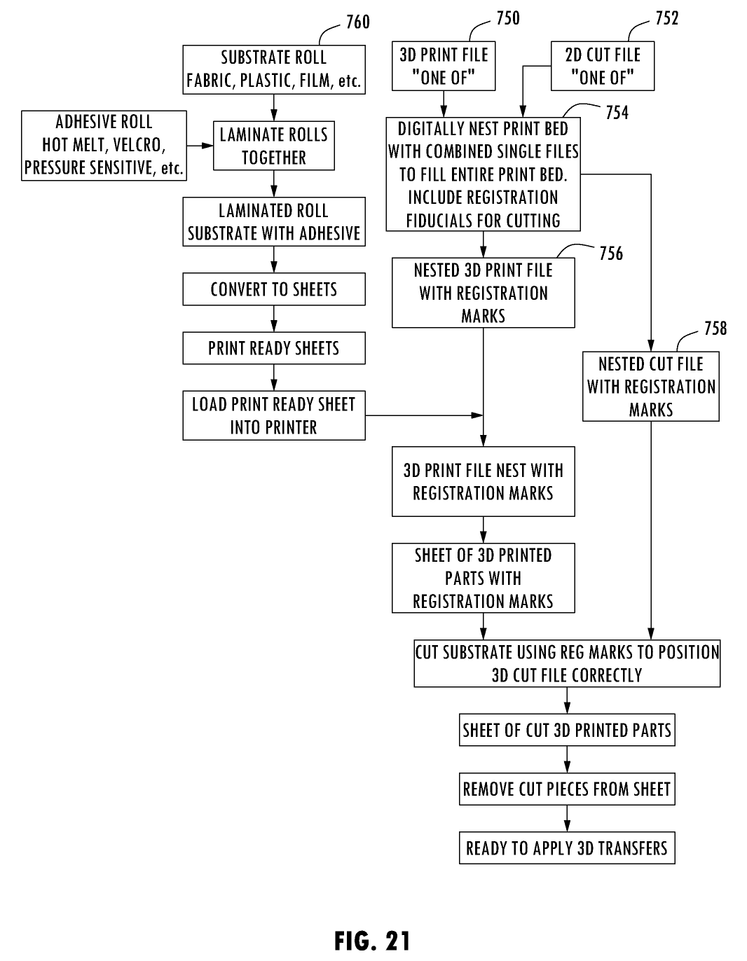

Referring now to FIG. 21, a comprehensive flowchart is provided that illustrates the manufacturing process for producing dimensional appliques. The process begins with the creation of digital design files, including a three-dimensional model file 750 (the "one-of" design) and a corresponding two-dimensional cut contour file 752. Multiple one-of designs are gathered and arranged in a nesting operation 754 using nesting software that optimizes the layout for the available print bed area. The nesting operation 754 produces a nested 3D print file 756 containing all designs arranged for batch production, along with registration fiducials positioned at appropriate locations. A corresponding nested cut file 758 contains all cut contours with registration fiducials aligned to match the print file. In parallel, substrate preparation 760 is performed using one of the methods described above (lamination, selective adhesive application, or cut-and-weed) to produce print-ready substrate sheets with adhesive layers applied.

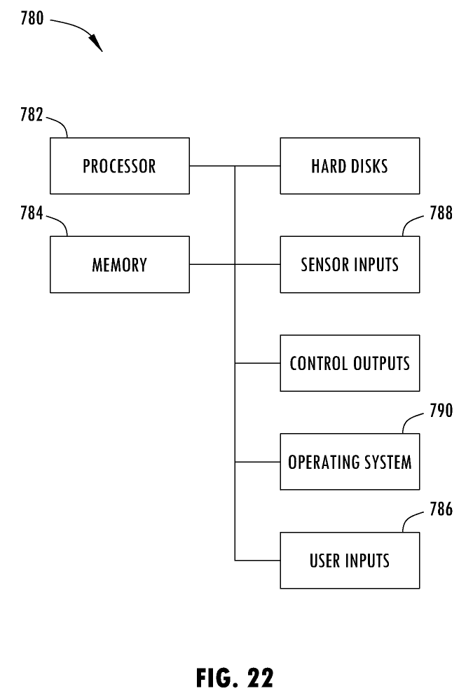

As shown in FIG. 22, a schematic diagram of a control system 780 for coordinating the operation of the apparatus. The control system 780 comprises at least one processor 782, memory 784, input/output interfaces 786, and control software executing on the processor 782. The processor 782 may comprise a central processing unit (CPU), microcontroller, field-programmable gate array (FPGA), or other programmable logic device capable of executing control instructions. The memory 784 includes both volatile memory (such as RAM) for temporary data storage and processing, and non-volatile memory (such as flash memory, solid-state drives, or hard disk drives) for storing firmware, software applications, configuration data, and job files. The control software 790 includes modules for print job management, motion control, material dispensing control, UV curing control, substrate handling control, and cutting system control. These modules coordinate to execute the complete manufacturing workflow from substrate loading through final applique removal. For example, the print job management module receives digital model files (3D print files and 2D cut files), performs slicing operations to convert 3D models into layer-by-layer instructions, manages job queues, and coordinates handoffs between printing, support removal, and cutting operations. The motion control module controls the positioning and movement of print heads, cutting tools, and substrate handling mechanisms. Feedback from optical encoders and position sensors 788 enables closed-loop position control with high accuracy. The input interfaces 786 provide connections to various sensors and actuators for operator interaction. The control system 780 may also include network interfaces for connecting to external systems, such as design workstations where digital models are created, production management systems that track orders and inventory, and remote monitoring systems that enable technicians to diagnose issues and perform maintenance. The integration and automation provided by the control system 780 enables efficient, consistent production of dimensional appliques with minimal operator intervention. Once substrate sheets are loaded and job files are selected, the system can automatically execute printing, curing, support removal (if automated wash stations are integrated), cutting, and waste removal with appropriate coordination and error checking at each stage.

The dimensional applique and associated manufacturing methods and apparatus disclosed herein provide significant advantages for numerous industries and applications. In the apparel and textile decoration industry, the technology enables production of high-quality dimensional graphics for sportswear, uniforms, corporate apparel, fashion products, footwear, and accessories. The ability to produce photographic-quality full-color images with dimensional relief and tactile effects opens new creative possibilities for designers and brands. The batch production approach fundamentally changes the economics of dimensional graphic production, making dimensional graphics accessible for applications and order quantities that would be cost-prohibitive with direct printing methods.

For purposes of this disclosure, the articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote one element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A dimensional applique, comprising:
a three-dimensional printed photopolymer structure having a base layer and a plurality of raised layers disposed on the base layer; and
an adhesive layer disposed beneath the base layer and configured to bond the dimensional applique to a target surface upon activation,
wherein the three-dimensional printed photopolymer structure defines a printed image featuring full-color gradients and texture variation.

2. The dimensional applique of claim 1, wherein the adhesive layer comprises at least one of a thermally activated hot-melt adhesive configured to bond to a target surface upon heating to an activation temperature or a pressure-sensitive adhesive configured to bond to a target surface without thermal activation.

3. The dimensional applique of claim 1, wherein the adhesive layer comprises a thermally activated hot-melt adhesive that includes at least one of thermoplastic polyurethane, polyester-based hot-melt adhesives, or polyolefin-based adhesives.

4. The dimensional applique of claim 1, wherein the adhesive layer comprises at least one of a thermally activated hot-melt adhesive configured to bond to a target surface upon heating to an activation temperature, and wherein the three-dimensional printed photopolymer structure has a degradation temperature that is greater than the activation temperature.

5. The dimensional applique of claim 1, wherein the three-dimensional printed photopolymer structure has a height between the adhesive layer and an outer surface of the plurality of raised layers that varies over the three-dimensional printed photopolymer structure.

6. The dimensional applique of claim 1, further comprising a substrate layer disposed between the three-dimensional printed photopolymer structure and the adhesive layer.

7. The dimensional applique of claim 6, wherein the substrate layer is selected from the group consisting of polyester fabric, nylon fabric, polyethylene terephthalate film, and polyurethane film.

8. The dimensional applique of claim 1, wherein the three-dimensional printed photopolymer structure comprises at least two different colored photopolymers deposited simultaneously to create full-color gradients.

9. The dimensional applique of claim 1, wherein the plurality of raised layers define a three-dimensional texture forming a visible pattern.

10. The dimensional applique of claim 1, wherein the three-dimensional printed photopolymer structure has a maximum height ranging from 0.5 mm to 5 mm above the adhesive layer.

11. An apparatus for producing dimensional applique graphics, comprising:
a printing system configured to deposit liquid photopolymer onto a substrate in successive layers to form a three-dimensional structure;
an ultraviolet curing system positioned to cure each deposited layer of photopolymer immediately after deposition; and
a cutting system comprising a cutting tool and positioned to receive the substrate after printing, the cutting system configured to separate individual dimensional appliques from the substrate based on pre-defined cut contour.

12. The apparatus of claim 11, further comprising:
an optical registration system configured to detect registration fiducials printed as part of the three-dimensional structure and align the pre-defined cut contours with the three-dimensional structure.

13. The apparatus of claim 12, wherein the cutting system comprises a laser cutter integrated with an optical registration system configured to detect the registration fiducials and align cut paths with the three-dimensional structure.

14. The apparatus of claim 11, further comprising an adhesive application system configured to apply an adhesive layer to the substrate before printing, wherein the adhesive layer is configured to activate at a temperature below a degradation temperature of the cured photopolymer.

15. The apparatus of claim 11, further comprising:
a substrate handling system including a vacuum hold-down platform for securing the substrate during printing, wherein the substrate handling system further comprises optical sensors configured to detect positioning of the substrate and adjust vacuum hold-down force to maintain precise alignment during printing and cutting operations.

16. A method of manufacturing a dimensional applique, comprising:
preparing a substrate with an adhesive layer configured to activate at a temperature below a degradation temperature of a cured photopolymer;
depositing liquid photopolymer onto the substrate using a printing system to form a three-dimensional structure in successive layers;
curing each deposited layer with ultraviolet light immediately after deposition;
cutting the three-dimensional structure from the substrate using a precision cutting system aligned with registration fiducials formed as part of the three-dimensional structure; and
removing the dimensional applique from the substrate for subsequent application to a target surface.

17. The method of claim 16, wherein the adhesive layer comprises a thermally activated adhesive, and further comprising:
positioning the dimensional applique on a textile surface; and
applying heat and pressure using a heat press with bottom heat to activate the adhesive layer without damaging the three-dimensional structure.

18. The method of claim 17, further comprising:
placing a pressure distribution pad between a press platen and the three-dimensional structure during application, wherein the pressure distribution pad has mechanical properties configured to distribute force evenly across varying surface heights of the dimensional applique.

19. The method of claim 16, wherein preparing the substrate comprises:
laminating a roll of adhesive material to a roll of substrate material to form a roll of laminated material; and
converting the laminated material into sheets dimensioned to fit a print bed of the printing system.

20. The method of claim 16, wherein the three-dimensional structure comprises a plurality of individual dimensional appliques arranged in a nested configuration on the substrate, and wherein cutting comprises separating each individual dimensional applique based on respective pre-defined cut contours.
